(19) United States
(12) Patent Application Publication
(10) Pub. No.: US 2025/0117475 A1
(43) Pub. Date: Apr. 10, 2025

(54) SYSTEMS AND METHODS FOR DETECTING FRAUDULENT BROWSER EXTENSIONS

(71) Applicant: Capital One Services, LLC, McLean, VA (US)

(72) Inventor: Anthony GLYNN, Fairfax, VA (US)

(73) Assignee: Capital One Services, LLC, McLean, VA (US)

(21) Appl. No.: 18/481,653

(22) Filed: Oct. 5, 2023

(51) Int. Cl. G06F 21/55

(52) U.S. Cl. CPC G06F 21/554; G06F 2221/033

(57) ABSTRACT

Methods and systems for detecting fraudulent browser extensions are described herein. In some aspects, the system may retrieve a first unique identifier corresponding to a browser extension associated with a beacon and retrieve a second unique identifier associated with an embedded frame in a new browser extension. The system may determine whether the new browser extension is a spoofed version of the browser extension based on whether the first identifier of the browser extension matches the second identifier of the new browser extension. In response to determining that the new browser extension is spoofed, the system may execute an application programming interface (API) function to transmit a notification to an external server. The API function can be configured to generate information to include in the notification regarding the new browser extension. This allows the system to identify spoofed browser extensions and transmit a notification accordingly.

### SUMMARY

Browser extensions have become increasingly popular and are used across various platforms and browsers. Browser extensions are add-ons or plugins that help provide many useful features to augment the functionality of web browsers. Key benefits of browser extensions include adding functionality to the web browser and providing convenience and additional features for the user. Examples include browser extensions for coupon discovery and presentation, password managers, ad blockers, virtual private network (VPN) services, custom themes or skins, or social media integration.

However, despite these benefits and despite the wide-ranging number of potential applications, practical implementations of browser extensions have been hindered by several technical problems. First, given the widespread use and broad functionality of web browsers, and access to sensitive information entered by the user, especially in the case of password managers or extensions that require entering credentials to link to another institution (e.g., logging into a financial institution through the web extension), browser extensions are a prime attack target for bad actors to launch a phishing attack in an attempt to steal or intercept user credentials. Second, despite the mainstream popularity of browser extensions, practical implementations may require specialized knowledge to design, program, and integrate security measures to ensure browser extensions are authentic and unlikely to be a bad actor posing as a developer to phish user credentials. Finally, because the browser extensions are developed using web technologies like HTML, CSS, and JavaScript and published on browser extension stores, the source code is accessible, human-readable, and easily copied. Due to the openness of browser extension source code, bad actors can read the code and identify potential vulnerabilities or create counterfeit versions of browser extensions by simply copying and pasting the source code. These technical problems may present an inherent problem with attempting to identify counterfeit browser extensions quickly and take appropriate countermeasures to ensure phishing attacks are not unsuccessful.

Methods and systems are described herein for novel uses and/or improvements to developing browser extensions with user privacy in mind. As one example, methods and systems are described herein for preventing phishing attacks through browser extension impersonation independent of the associated domain.

Existing systems fail to prevent phishing attacks through browser extension impersonation due to a lack of authenticity checks before, during, or after the development and deployment of the browser extension. Specifically, there are no strong methods for users to verify that browser extensions are authentic. For example, existing browser extensions have an architecture in which they can restrict their functionality to only appear for certain domains (e.g., based on a browser extension unique identifier), but many browser extensions choose to appear across all domains making traditional methods (e.g., domain whitelisting/blacklisting) of identifying fraudulent or counterfeit browser extensions ineffective. However, creating a browser extension that can identify and report impersonation attacks faces several technical challenges, such as the non-static domain names associated with the browser extension and a lack of security measures, such as code obfuscation.

To overcome these technical deficiencies for this practical benefit, methods and systems disclosed herein use a beacon to compare a unique browser extension identifier (e.g., a unique identifier) to another unique browser extension identifier (e.g., the ID tag associated with the iFrame element) and transmit a notification to an external server regarding whether the browser extension is a spoofed version of another browser extension. Using the beacon to compare the unique browser extension identifier mitigates the need for traditional security measures centered around domains or code obfuscation because the beacon is integrated with the source code for the non-spoofed, original browser extension. It is unlikely that bad actors will stop attempting to counterfeit software in hopes of phishing users out of sensitive credentials. Therefore, by acting on the assumption that bad actors will replicate a genuine browser extension by copying source code, a code snippet (e.g., the beacon) can be included in the source code that performs local comparisons to ensure the browser extension is genuine and notify the publisher of the genuine browser extension regarding the existence of the counterfeit browser extension. For example, the system can use a beacon to perform a check on the unique identifier of the browser extension and determine whether the unique identifier of the browser extension matches the known unique identifier, where a match indicates the browser extension is genuine. Alternatively, the system can generate a notification that the unique identifier of the browser extension does not match the known unique identifier. Specifically, the system can transmit an HTTP request to an endpoint that includes the unique identifier associated with the spoofed browser extension, thereby notifying the owner of the genuine browser extension of the existence of the fraudulent spoofed browser extension. Accordingly, the methods and systems described herein provide the practical benefit of preventing phishing attacks through browser extension impersonation independent of the associated domain.

In some implementations, the system retrieves a first unique identifier corresponding to a browser extension associated with a beacon (e.g., the trusted ID from the browser extension store). After retrieving the first unique identifier, the system retrieves a second unique identifier associated with an embedded frame in a new browser extension (e.g., a universally unique identifier (UUID) associated with the iFrame element). The system determines whether the new browser extension is a spoofed version of the browser extension based on whether the first unique identifier of the browser extension matches the second unique identifier of the new browser extension. In response to determining that the new browser extension is a spoofed version of the browser extension, the system executes an application programming interface (API) function to transmit a notification to an external server (e.g., an API function that triggers an HTTP PUT request that requests “putting” the second unique identifier associated with the new browser extension on a list of fraudulent browser extensions). The API function is configured to generate information to include in the notification regarding the new browser extension (e.g., the first unique identifier).

Various other aspects, features, and advantages of the systems and methods described herein will be apparent through the detailed description and the drawings attached hereto. It is also to be understood that both the foregoing general description and the following detailed description are examples and are not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of a beacon for preventing phishing through browser extension impersonation attacks independent of the associated domain, in accordance with one or more embodiments.

FIG. 2 shows an illustrative diagram for using a beacon to identify new browser extensions that are spoofed, in accordance with one or more embodiments.

FIG. 3 shows an illustrative diagram for using a beacon to identify a spoofed browser extension and transmit a notification to an external server, in accordance with one or more embodiments.

FIG. 4 shows illustrative components for a system used to identify spoofed browser extensions, in accordance with one or more embodiments.

FIG. 5 shows a flowchart of the steps involved in identifying and reporting impersonation attacks using a beacon, in accordance with one or more embodiments.

### DETAILED DESCRIPTION

In the following description, for the purposes of explanation, numerous specific details are set forth in order to provide a thorough understanding of the embodiments of the systems and methods described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

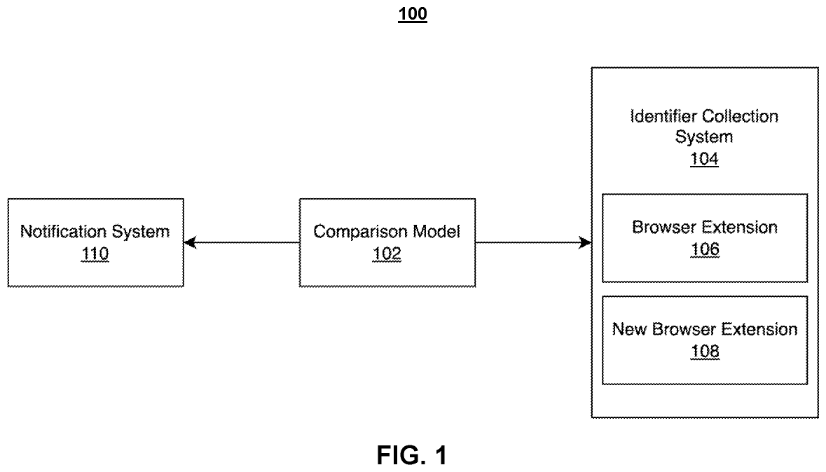

FIG. 1 shows an illustrative diagram for preventing phishing through browser extension impersonation attacks independent of the associated domain, in accordance with one or more embodiments. For example, system 100 may include comparison model 102, notification system 110, and identifier collection system 104. Within identifier collection system 104, there is a browser extension 106 and a new browser extension 108. For example, browser extension 106 may be the authentic or original browser extension. In contrast, the new browser extension 108 may be a spoofed version of browser extension 106. By using comparison model 102 in addition to identifier collection system 104, the system may be able to detect whether new browser extension 108 is, in fact, a spoofed version of browser extension 106. Upon making this determination, notification system 110 may transmit an API request to an external server. The API function may be configured to generate information for the notification regarding the new browser extension, such as the name of the browser extension, the browser extension store, where it can be downloaded from or accessed by other users, or the unique identification number associated with the new browser extension.

For example, FIG. 1 illustrates one implementation of a beacon that includes comparison model 102 to determine whether new browser extension 108 is a spoof version of browser extension 106. Conventional approaches may be unable to make this determination due to the lack of a beacon in the browser extension (e.g., browser extension 106). For example, the system may use identifier collection system 104 to collect information from browser extension 106 and new browser extension 108. The data collected by identifier collection system 104 can include unique identifiers and other metadata corresponding to either browser extension 106 or new browser extension 108. The comparison model 102 may use the information gathered to determine the validity of the browser extension. If comparison model 102 determines that the new browser extension is spoofed, comparison model 102 can communicate with notification system 110. As such, the system may be able to prevent phishing through browser extension impersonation attacks independent of the domain associated with the browser extension.

The system may be used to identify if a new browser extension is a copy of the original or authentic version of the browser extension. In disclosed embodiments, an original version of the browser extension may include the browser extension as initially published by the original author. For example, if an entity releases a browser extension that does not replicate or copy a preexisting browser extension, the browser extension can be said to be an original browser extension.

The system may be used to identify spoofed browser extensions. In disclosed embodiments, a spoofed version of a browser extension may be a browser extension with source code very similar or the same as the source code for the original browser extension. For example, if an entity releases a browser extension, and two months later, a new browser extension with the same source code appears, the new browser extension can be said to be a spoofed version of the original browser extension.

The system may identify a spoofed browser extension based on a comparison that relies in part on an embedded frame in a browser extension. In disclosed embodiments, an embedded frame in a browser extension is an HTML element that can overlay content over the current HTML page. For example, a browser extension responsible for collating and presenting coupons to use on a web store checkout page may use an embedded frame to allow data to be presented to the user without compromising the layout of the web store checkout page. For example, the embedded frame can be an iFrame HTML element that includes an iFrame ID, which can be the unique identifier of a browser extension.

The system may be used to identify a spoofed browser extension by using a unique identifier. In disclosed embodiments, a unique identifier is an alphanumeric string constrained by a set of predetermined rules (e.g., length, number requirements, or letter requirements) that can uniquely identify a browser extension. In some embodiments, the unique identifier may be tied to a specific web browser extension store. Furthermore, the same browser extension may be accessible from multiple browser extension stores, with each store providing a unique identifier to the extension. For example, a browser extension released on a first browser extension store may have a unique identifier that differs from a unique identifier associated with a browser extension released on a second browser extension store.

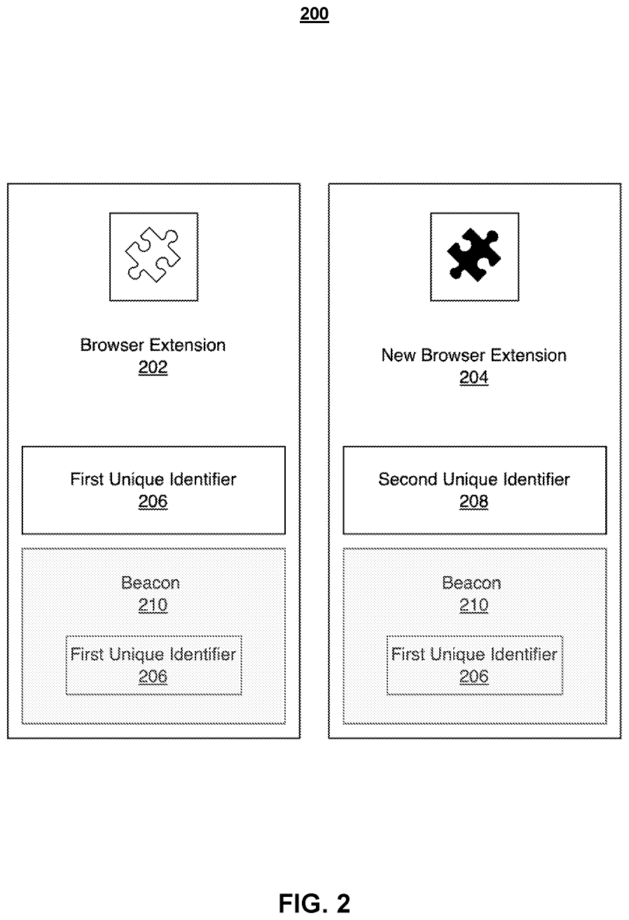

FIG. 2 shows an illustrative diagram for using a beacon (e.g., the beacon presented in FIG. 1) to identify new browser extensions that are spoofed, in accordance with one or more embodiments. System 200 depicts a more detailed view of browser extension 202 and the new browser extension 204. Browser extension 202 includes the first unique identifier 206 and beacon 210. Beacon 210 includes the first unique identifier 206. FIG. 2 also includes the new browser extension 204. New browser extension 204 can include a second unique identifier 208 and beacon 210. For example, the new browser extension can be a spoofed version of the browser extension 202.

In some cases, bad actors trying to phish user information by replicating an official browser extension may copy the source code associated with the official browser extension and republish it to the same or a similar browser extension store. For example, the bad actor may replicate an extension that is associated with a bank and provides a user with coupons when making online purchases. The extension may require the user to log in using their respective bank credentials to access the coupons. If the attacker successfully gathers the login information associated with the user, the attacker can impersonate the user to access the bank and perform actions as the user.

However, if an attacker copies the source code of browser extension 202 in an attempt to gather user credentials, beacon 210 will be included in the copied source code. In the new browser extension 204, the beacon 210 may include the first unique identifier 206 included in browser extension 202. The first unique identifier 206 may be included in beacon 210 in plaintext as part of the code snippet.

By including the first unique identifier 206 in the beacon 210, the system can use a comparison model in the beacon (e.g., comparison model 102) to determine if the second unique identifier 208, included in new browser extension 204, is the same as the first unique identifier 206. If the second unique identifier 208 is the same as the first unique identifier 206 included in beacon 210, the system may determine that the new browser extension 204 is a spoofed version of browser extension 202. Alternatively, if the second unique identifier 208 is not the same as the first unique identifier 206, the system may determine that the new browser extension 204 is not a spoofed version of the browser extension 202.

In some embodiments, comparing the first unique identifier 206 to the second unique identifier 208 does not provide sufficient information to conclude that the new browser extension 204 is a spoofed version of browser extension 202. For example, a browser extension might be released on separate extension stores and, therefore, may have different unique identifiers. For example, in some cases, more information is required by the comparison model to determine that a browser extension is fraudulent. The additional information required by the comparison model could be metadata corresponding to the browser extension or the new browser extension.

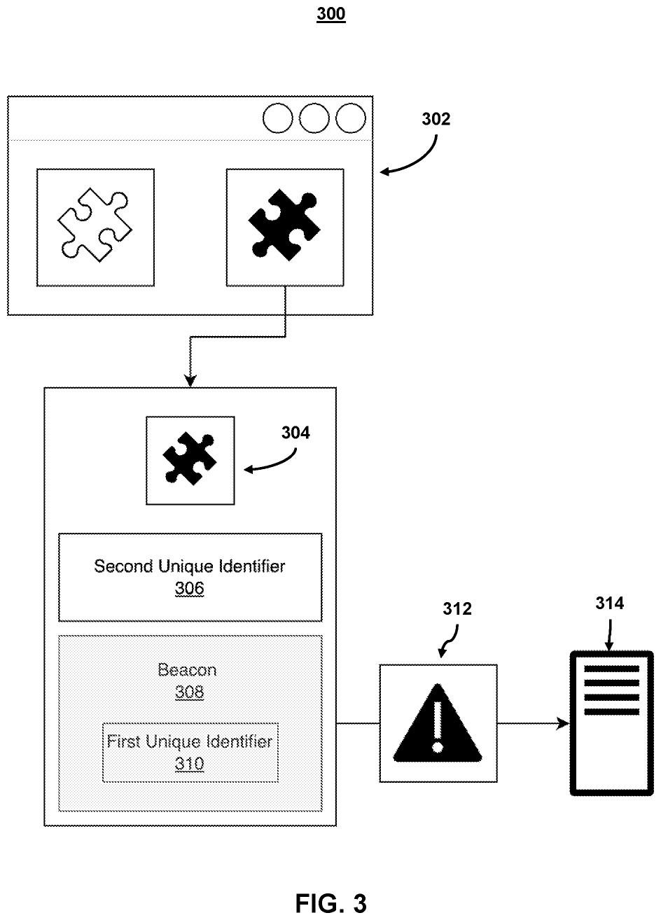

FIG. 3 shows an illustrative diagram for using a beacon to identify a spoofed browser extension and transmit a notification to an external server, in accordance with one or more embodiments. System 300 includes browser extension store 302. Browser extension store 302 can host a variety of browser extensions to make them accessible to users. Browser extension store 302 can host a browser extension and a spoofed browser extension (e.g., spoofed browser extension 304). The spoofed browser extension 304 may have the same source code as the browser extension.

A user may download spoofed browser extension 304 from browser extension store 302. Spoofed browser extension 304 may be a copy of a legitimate browser extension. Spoofed browser extension 304 may have been released by a bad actor in an attempt to phish user credentials using an impersonation attack.

Spoofed browser extension 304 may include a beacon (e.g., beacon 308). Beacon 308 may be responsible for notifying an external server of the existence of a spoofed browser extension. The beacon 308 may be initiated by a user who downloads a browser extension (e.g., downloading an extension from browser extension store 302). The user may download an extension from common browser extension stores.

After a beacon is downloaded by the user from a browser extension store (e.g., browser extension store 302), beacon 308 may be activated. The beacon may be a snippet of code that does not begin to identify spoofed browser extensions until the downloaded browser extension is connected to the web browser or used by the user. Waiting until the user installs the extension may reduce the number of false positives the system transmits to the external server. False positives may be a concern when developers are working on or updating the web extension with potentially different unique identifiers.

After beacon 308 is activated, the beacon may reference information included in the spoofed browser extension 304, such as the second unique identifier. The first unique identifier 310 may be a unique identifier associated with the legitimate and non-spoofed version of spoofed browser extension 304. The first unique identifier 310 may be hard-coded into beacon 308. Alternatively, the first unique identifier 310 may be accessible by the beacon 308 using an API request. The second unique identifier 306 may be assigned to the spoofed browser extension 304 by browser extension store 302 at the time of publishing or approval. The first unique identifier may be a 32-character identifier that can differentiate the spoofed browser extension.

Furthermore, the beacon 308 may reference information included in the spoofed browser extension 304, such as the second unique identifier 306. The beacon 308 may compare the unique identifiers as well as generate a notification (e.g., notification 312). The notification 312 may include information about the spoofed browser extension 304 and the browser extension associated with the first unique identifier 310. For example, the information in the notification may include the name associated with the browser on the corresponding browser extension store (e.g., browser extension store 302) or the second unique identifier (e.g., second unique identifier 306).

The beacon may execute an API function to transmit a notification to an external server (e.g., external server 314) for further analysis. The notification may be in the form of an HTTP PUT request. The request may contain information regarding the suspected spoofed browser extension to be included in an external server's database (e.g., a database of suspected spoofed browser extensions). This information may include the new browser extension's name, unique identifier, and other relevant data. The HTTP PUT request may also include the destination URL of the associated external server 314. If the browser extension is a spoofed version, a notification can be sent to inform the appropriate entities. After receiving the notification, the appropriate entities can take the necessary actions to remove the extension from the hosting browser extension store.

The system may divide the unique identifier into one or more portions. In disclosed embodiments, a portion may include a subset of a complete unique identifier separated by a specific number of characters. For example, a unique identifier can be made up of various sections. For example, the sections may be “portion A” and “portion B,” which make up the unique identifier when combined. In some embodiments, the system may determine a portion by segmenting the unique identifier into distinct sections based on predefined criteria or rules, such as length, content, or sequence.

The system may use reference metadata to compare to the metadata of the new browser extension. The reference metadata may identify data associated with the browser extension associated with the beacon. The reference metadata can include characteristics and attributes (e.g., title, release or publication date, hash values, or a unique identifier). The system may also reference metadata from the new browser extension, including characteristics and attributes of the new browser extension (e.g., title, release or publication date, hash values, or a unique identifier). The system may be able to determine if the new browser extension is a spoofed version of the browser extension by comparing one or more portions of the metadata. For example, if the metadata associated with the new browser extension includes a hash value corresponding to the source code and the hash value of the source code associated with the browser extension does not comport with the hash associated with the new browser extension, the new browser extension may be spoofed.

The system may use a server that keeps track of multiple unique identifiers of the browser extension (e.g., in the case of the same extension being released and accessible from multiple browser extension stores). For example, the system may use a server that stores two unique identifiers associated with the same browser extension. The browser extension may have different unique identifiers due to the accessibility of the browser extensions across browser extension stores. In some embodiments, the multiple unique identifiers may comprise a string of alphanumeric characters assigned by the store hosting the browser extension.

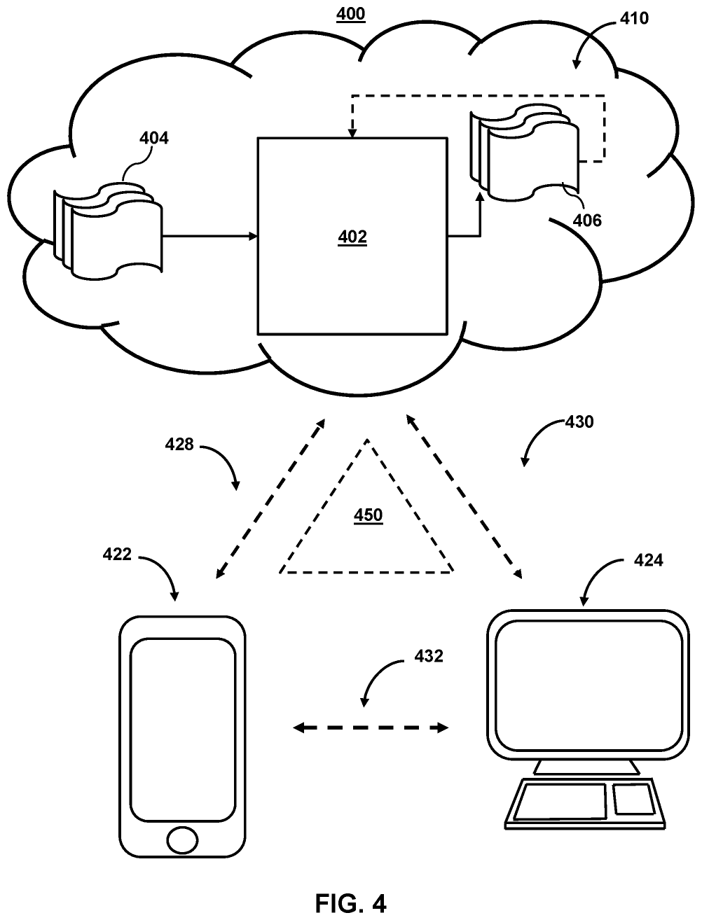

FIG. 4 shows illustrative components for a system used to identify spoofed browser extensions, in accordance with one or more embodiments. For example, FIG. 4 may show illustrative components for identifying spoofed browser extensions using a beacon embedded in the source code of a browser extension. As shown in FIG. 4, system 400 may include mobile device 422 and user terminal 424. While shown as a smartphone and personal computer, respectively, in FIG. 4, it should be noted that mobile device 422 and user terminal 424 may be any computing device, including, but not limited to, a laptop computer, a tablet computer, a handheld computer, and other computer equipment (e.g., a server), including “smart,” wireless, wearable, and/or mobile devices. FIG. 4 also includes cloud components 410. Cloud components 410 may alternatively be any computing device as described above and may include any type of mobile terminal, fixed terminal, or other device. For example, cloud components 410 may be implemented as a cloud computing system and may feature one or more component devices. It should also be noted that system 400 is not limited to three devices. Users may, for instance, utilize one or more devices to interact with one another, one or more servers, or other components of system 400. It should be noted that, while one or more operations are described herein as being performed by particular components of system 400, these operations may, in some embodiments, be performed by other components of system 400. As an example, while one or more operations are described herein as being performed by components of mobile device 422, these operations may, in some embodiments, be performed by components of cloud components 410. In some embodiments, the various computers and systems described herein may include one or more computing devices that are programmed to perform the described functions. Additionally, or alternatively, multiple users may interact with system 400 and/or one or more components of system 400. For example, in one embodiment, a first user and a second user may interact with system 400 using two different components.

With respect to the components of mobile device 422, user terminal 424, and cloud components 410, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., conversational responses, queries, and/or notifications).

Additionally, as mobile device 422 and user terminal 424 are shown as a smartphone and personal computer, respectively, these displays also act as user input interfaces. It should be noted that, in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 400 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communications networks or combinations of communications networks. Communication paths 428, 430, and 432 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may include notification system 110, comparison model 102, or identifier collection system 104, which can be accessed by a beacon in a browser extension (e.g., beacon 308).

Cloud components 410 may access unique identifiers associated with a browser extension (e.g., second unique identifier 306 or first unique identifier 310). Cloud components 410 may also access metadata corresponding to browser extensions based on their listing on a browser extension store. For example, cloud components 410 may use the unique identifier associated with the browser extension to extract additional data from the respective browser extension store.

Cloud components 410 may include model 402, which may be a machine learning model, artificial intelligence model, etc. (which may be referred to collectively as “models” herein). Model 402 may take inputs 404 and provide outputs 406. The inputs may include multiple datasets, such as a training dataset and a test dataset. Each of the plurality of datasets (e.g., inputs 404) may include data subsets related to user data, predicted forecasts and/or errors, and/or actual forecasts and/or errors. In some embodiments, outputs 406 may be fed back to model 402 as input to train model 402 (e.g., alone or in conjunction with user indications of the accuracy of outputs 406, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., is a spoofed version of the browser extension or is not a spoofed version of the browser extension).

In a variety of embodiments, model 402 may update its configurations (e.g., weights, biases, or other parameters) based on the assessment of its prediction (e.g., outputs 406) and reference feedback information (e.g., user indication of accuracy, reference labels, or other information). In a variety of embodiments, where model 402 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 402 may be trained to generate better predictions.

In some embodiments, model 402 may include an artificial neural network. In such embodiments, model 402 may include an input layer and one or more hidden layers. Each neural unit of model 402 may be connected with many other neural units of model 402. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 402 may be self-learning and trained, rather than explicitly programmed, and can perform significantly better in certain areas of problem solving as compared to traditional computer programs. During training, an output layer of model 402 may correspond to a classification of model 402, and an input known to correspond to that classification may be input into an input layer of model 402 during training. During testing, an input without a known classification may be input into the input layer, and a determined classification may be output.

In some embodiments, model 402 may include multiple layers (e.g., where a signal path traverses from front layers to back layers). In some embodiments, backpropagation techniques may be utilized by model 402 where forward stimulation is used to reset weights on the “front” neural units. In some embodiments, stimulation and inhibition for model 402 may be more free-flowing, with connections interacting in a more chaotic and complex fashion. During testing, an output layer of model 402 may indicate whether or not a given input corresponds to a classification of model 402 (e.g., spoofed browser extension or not spoofed browser extension).

In some embodiments, the model (e.g., model 402) may automatically perform actions based on outputs 406. In some embodiments, the model (e.g., model 402) may not perform any actions. The output of the model (e.g., model 402) may be used to determine if a browser extension is spoofed or to generate a notification to the server including information about the spoofed browser extension.

System 400 also includes API layer 450. API layer 450 may allow the system to generate summaries across different devices. In some embodiments, API layer 450 may be implemented on mobile device 422 or user terminal 424. Alternatively or additionally, API layer 450 may reside on one or more of cloud components 410. API layer 450 (which may be a REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web services, using resources like Service Repository and Developer Portal, but with low governance, standardization, and separation of concerns. Alternatively, system 400 may be fully based on API layer 450, such that separation of concerns between layers like API layer 450, services, and applications are in place.

In some embodiments, the system architecture may use a microservice approach. Such systems may use two types of layers: front-end layer and back-end layer, where microservices reside. In this kind of architecture, the role of the API layer 450 may provide integration between the front end and back end. In such cases, API layer 450 may use RESTful APIs (exposition to the front end or even communication between microservices). API layer 450 may use AMQP (e.g., Kafka, RabbitMQ, etc.). API layer 450 may use incipient usage of new communications protocols such as gRPC, Thrift, etc.

In some embodiments, the system architecture may use an open API approach. In such cases, API layer 450 may use commercial or open source API Platforms and their modules. API layer 450 may use a developer portal. API layer 450 may use strong security constraints applying WAF and DDOS protection, and API layer 450 may use RESTful APIs as standard for external integration.

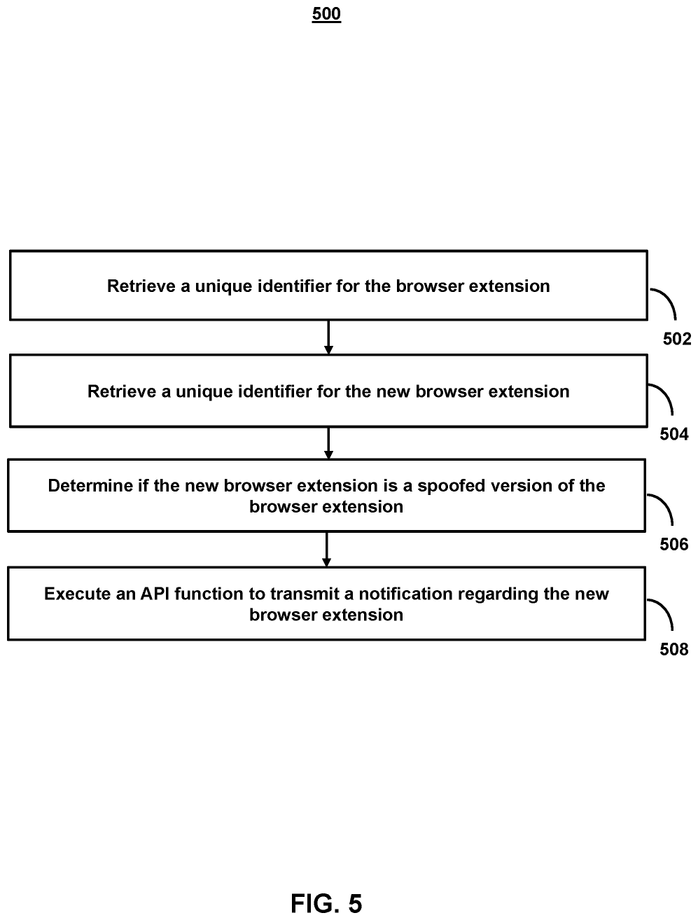

FIG. 5 shows a flowchart of the steps involved in identifying spoofed browser extensions by comparing unique identifiers, in accordance with one or more embodiments. For example, the system may use process 500 (e.g., as implemented on one or more system components described above) to prevent phishing or other attacks through browser extension impersonation attacks independent of any domain associated with the browser extension.

At step 502, process 500 (e.g., using one or more components described above) retrieves a unique identifier for the browser extension. For example, the system may, in response to installation of a new browser extension previously not present on a user device, execute code for a beacon comprising retrieving a first unique identifier corresponding to a browser extension associated with the beacon. For example, the system may retrieve a unique ID associated with the browser extension (e.g., the unique identifier) code by calling one or more browser-provided runtime APIs. By retrieving a unique identifier for the browser extension, the system can identify the browser extension corresponding to the beacon, which serves as verification that the browser extension is authentic and not spoofed.

In some embodiments, the system may access a local file on the user device to receive the identifier associated with the beacon. For example, the system may retrieve the first unique identifier corresponding to the browser extension associated with the beacon by accessing a local file to retrieve the first unique identifier, wherein the local file comprises the first unique identifier corresponding to the browser extension associated with the beacon and wherein the local file is stored on a user device that stores the browser extension. For example, a browser extension may be installed on a browser on a desktop computer. The desktop computer may have a filing structure that includes one or more files associated with the browser extension. The files associated with the browser extension can include a key that corresponds to the unique identifier as well as the metadata about the extension, such as name, version, description, permissions, and other relevant information. By accessing a local file on the user device to receive the identifier associated with the beacon, the system may be able to authenticate the new browser extension based on comparing the unique identifier corresponding to the beacon regardless of the internet browser associated with the extension.

At step 504, process 500 (e.g., using one or more components described above) retrieves a unique identifier for the new browser extension. For example, the system may retrieve a second unique identifier associated with an embedded frame in a new browser extension. For example, similarly to how the system retrieved the identifier associated with the beacon, the system may retrieve the unique ID associated with the new browser extension from the local file on the device where the new browser extension is installed. By retrieving a unique identifier for the new browser extension, the system can identify information that may indicate that the new browser extension is a spoofed version of the browser extension.

In some embodiments, the system may access multiple files to retrieve and aggregate one or more portions of the unique identifier. For example, the local file can comprise a first portion of the first unique identifier, and a second local file can comprise a second portion of the first unique identifier. The first unique identifier can be a combination of the first portion of the first unique identifier and the second portion of the first unique identifier. For example, the system may identify the unique identifier by combining a first portion of the identifier from one local file and a second portion of the identifier from another local file. For example, the user device may include two or more local files, each with a portion of the unique identifier. The system may identify the unique identifier by aggregating the portions of the unique identifier from two or more local files to form the full unique identifier. By accessing multiple files to retrieve and aggregate one or more portions of the identifier, the system may be able to obfuscate the unique identifier to reduce the likelihood that a bad actor who is spoofing a browser extension can identify the unique identifier.

In some embodiments, the system may retrieve the browser extension from various sources, each with a unique identifier. For example, the browser extension may be available from a plurality of sources, wherein each source provides a different unique identifier for the browser extension. For example, the system may retrieve the browser extension from various extension stores, each with a unique validation and certification process. For example, a browser could assign a unique identifier in a different format or length than another browser. By retrieving the browser extension from various sources, each with a unique identifier, the system may be able to verify the authenticity of the new browser extension regardless of the browser extension store from which the new browser extension was downloaded or on which the new browser extension is hosted and distributed.

In some embodiments, the system may retrieve fragments and encode portions of the code associated with the browser extension. For example, the first unique identifier of the browser extension may be broken apart into a number of portions by the system and distributed in the new browser extension. Furthermore, each of the portions can be encoded. For example, the system may break apart the unique identifier into portions and encode using one or more encryption methods. By retrieving fragments and encoded portions of the code associated with the browser extension, the system may preserve the benefits from fragmenting and encoding portions of the unique ID associated with the browser extension (e.g., it may be harder for an attacker to identify and duplicate the unique identifier in the spoofed version of the browser extension).

In some embodiments, the system may receive the identifiers from a server. For example, the system may transmit requests to a server, wherein the server maintains a plurality of unique identifiers, and the system may receive, from the server, one or more of the plurality of unique identifiers. For example, the system may transmit one or more HTTP requests to a server that maintains a list of unique identifiers. In response to the HTTP request, the system may receive a unique identifier corresponding to the browser extension. By receiving identifiers from the server, the system may be able to verify the unique identifier corresponding to the browser extension if the hard-coded unique identifier is corrupted or inaccessible in the new browser extension.

At step 506, process 500 (e.g., using one or more components described above) determines if the new browser extension is a spoofed version of the browser extension. For example, the system may determine whether the new browser extension is a spoofed version of the browser extension based on whether the first unique identifier matches the second unique identifier of the new browser extension. For example, if after the system compares the unique identifier of the browser extension with the second unique identifier of the new browser extension, the system determines that they do not match, the new browser extension may be spoofed. Alternatively, if the system determines that the unique identifier of the browser extension is the same as the second unique identifier, the new browser extension may not be a spoofed version of the browser extension. By determining if the new browser extension is a spoofed version of the browser extension, the system can identify spoofed browser extensions that could be trying to phish sensitive user credentials using an impersonation attack with the spoofed browser extension.

In some embodiments, the system may execute the code for the beacon. For example, the system may execute code for the beacon by determining whether a first code for the beacon is missing, and in response to determining that the first code for the beacon is missing, executing a second code for the beacon to determine whether the new browser extension is the spoofed version of the browser extension. By executing the second code for the beacon, the system may include a redundant system of identifying spoofed browser extensions to reduce the likelihood that a spoofed browser extension is undetected.

In some embodiments, the system may identify spoofed browser extensions by using a third identifier. For example, the system may determine whether the new browser extension is a spoofed version of the browser extension by retrieving a third unique identifier corresponding to the browser extension, wherein the third unique identifier corresponds to the browser extension associated with the beacon, comparing the second unique identifier of the new browser extension with the third unique identifier, and determining whether the second unique identifier of the new browser extension matches the third unique identifier. For example, the beacon may be published to one or more stores accessible to users. Each store may assign a distinct unique ID to the browser extension. In such a case, the system may compare a third unique identifier corresponding to the new unique browser to a second unique identifier. The third unique identifier can be a browser extension store-specific identifier, an attribute of the browser extension associated with the beacon, or metadata that can be used to identify the browser extension associated with the beacon. For example, the third unique identifier could be a piece of data in a file associated with the browser extension (e.g., the author or icons). Not relying on the unique identifier to determine the authenticity of the browser extension can allow a single beacon to be integrated into browser extensions across browser extension stores. For example, if a browser extension is authentic but does not share a unique identifier, the third unique identifier can be used to verify its authenticity. By identifying spoofed browser extensions by using a third identifier, the system may be able to identify spoofed browser extensions regardless of which browser the browser extension corresponds to.

In some embodiments, the system may identify a spoofed version of a browser extension by comparing metadata instead of using only a unique identifier. For example, the system may further comprise identifying reference metadata from the browser extension associated with the beacon, wherein the reference metadata comprises characteristics and attributes of the browser extension, identifying second metadata from the new browser extension, wherein the second metadata comprises characteristics and attributes of the new browser extension, and determining whether the new browser extension is the spoofed version of the browser extension based on comparing the reference metadata and the second metadata. For example, the system may identify metadata in both the browser extension and the new browser extension. The metadata can include an extension ID, version information, the name of the extension on the respective extension store, a description on the store of the script, the browser extension, icons associated with the browser extension, information regarding the developer, including websites or other projects, and release date or dates of updates to the browser extension. By identifying a spoofed version of the browser extension by comparing metadata as opposed to using only a unique identifier, the system may have a redundant or alternative mechanism to validate the authenticity of the new browser extension.

In some embodiments, the new browser extension may be unverified. For example, the new browser extension is not verified by a trusted third-party authority, and wherein the new browser extension does not have a valid certificate. For example, the system may determine if the browser extension or the new browser extension is legitimate despite the new browser extension being unverified. The new browser extension may be unverified for various reasons, including being recently published to the browser extension store or being recently updated. Despite the new browser extension being unverified, the system may still be able to determine if the browser extension is spoofed.

At step 508, process 500 (e.g., using one or more components described above) executes an API function to transmit a notification regarding the new browser extension. For example, the system may, in response to determining that the new browser extension is a spoofed version of the browser extension, execute an application programming interface (API) function to transmit a notification to an external server, the API function configured to generate information to include in the notification regarding the new browser extension. For example, if the system determines that the new browser extension is a spoofed version of the browser extension, the author (e.g., the entity that published the browser extension) may want to be informed of the spoofed browser extension. The system may transmit a notification to an external server with information pertinent to the author regarding the spoofed browser extension. By executing an API function to transmit a notification regarding the new browser extension, the system may notify the owner or custodian of the browser extension that there is a spoofed version of the browser extension that could be performing malicious actions as the browser extension, thereby potentially damaging the reputation of the browser extension or phishing user credentials.

In some embodiments, the system may transmit a notification to a server regarding the spoofed browser extension. For example, the system may execute the API function to transmit a notification to an external server comprising a network request and wherein the network request comprises the second unique identifier of the spoofed version of the browser extension. For example, the system may send a notification to a server to identify spoofed browser extensions. The API function may include an HTTP request, such as an HTTP put request. The HTTP request may add data to a database, the data including data pertaining to the spoofed browser extension, such as the associated extension store where the browser extension is accessible and the source code. By transmitting a notification to a server regarding the spoofed browser extension, the system can alert the necessary parties to the existence of the spoof browser extension so that they can take further mitigating actions.

In some embodiments, the system may transform the identifier into a human-unreadable format. For example, the system may encode the first unique identifier of the browser extension by transforming the first unique identifier into a human-unreadable format. For example, the system may encode the unique identifier of the browser extension using one or more hashing functions (e.g., SHA-256 or MD5) and represent the code in hexadecimal. By transforming the extension ID into a human-unreadable format, it may be less likely that a human attempting to spoof the browser extension will succeed.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: in response to installation of a new browser extension previously not present on a user device, executing code for a beacon comprising: retrieving a first unique identifier corresponding to a browser extension associated with the beacon; retrieving a second unique identifier associated with an embedded frame in the new browser extension; determining whether the new browser extension is a spoofed version of the browser extension based on whether the first unique identifier of the browser extension matches the second unique identifier of the new browser extension; and in response to determining that the new browser extension is a spoofed version of the browser extension, executing an application programming interface (API) function to transmit a notification to an external server, the API function configured to generate information to include in the notification regarding the new browser extension.
2. A method comprising: retrieving a first unique identifier corresponding to a browser extension associated with a beacon; retrieving a second unique identifier associated with an embedded frame in a new browser extension; determining whether the new browser extension is a spoofed version of the browser extension based on whether the first unique identifier of the browser extension matches the second unique identifier of the new browser extension; and in response to determining that the new browser extension is a spoofed version of the browser extension, executing an application programming interface (API) function to transmit a notification to an external server, the API function configured to generate information to include in the notification regarding the new browser extension.
3. A method comprising: identifying a browser extension, wherein the browser extension comprises a first unique identifier corresponding to the browser extension; identifying a new browser extension, wherein the new browser extension comprises a second unique identifier associated with an embedded frame in the new browser extension; performing a check of the new browser extension by: comparing the second unique identifier of the new browser extension with the first unique identifier; and determining whether the second unique identifier of the new browser extension matches the first unique identifier; and executing an application programming interface (API) function to transmit a notification to an external server, the API function configured to generate information to include in the notification regarding the new browser extension.
4. The method of any one of the preceding embodiments, wherein retrieving the first unique identifier corresponding to the browser extension associated with the beacon further comprises: accessing a local file to retrieve the first unique identifier, wherein the local file comprises the first unique identifier corresponding to the browser extension associated with the beacon, and wherein the local file is stored on a user device that stores the browser extension.
5. The method of any one of the preceding embodiments, wherein the local file comprises a first portion of the first unique identifier, and a second local file comprises a second portion of the first unique identifier, and wherein the first unique identifier is a combination of the first portion of the first unique identifier and the second portion of the first unique identifier.
6. The method of any one of the preceding embodiments, wherein executing code for the beacon further comprises: determining whether a first code for the beacon is missing; and in response to determining that the first code for the beacon is missing, executing a second code for the beacon to determine whether the new browser extension is the spoofed version of the browser extension.
7. The method of any one of the preceding embodiments, wherein executing code for the beacon further comprises: determining whether a first code for the beacon is missing; and in response to determining that the first code for the beacon is missing, executing a second code for the beacon to determine whether the new browser extension is the spoofed version of the browser extension.
8. The method of any one of the preceding embodiments, wherein the browser extension is available from a plurality of sources, wherein each source provides a different unique identifier for the browser extension.
9. The method of any one of the preceding embodiments, wherein determining whether the new browser extension is a spoofed version of the browser extension further comprises: retrieving a third unique identifier corresponding to the browser extension, wherein the third unique identifier corresponds to the browser extension associated with the beacon; comparing the second unique identifier of the new browser extension with the third unique identifier; and determining whether the second unique identifier of the new browser extension matches the third unique identifier.
10. The method of any one of the preceding embodiments, wherein executing the API function to transmit a notification to an external server comprises a network request and wherein the network request comprises the second unique identifier of the spoofed version of the browser extension.
11. The method of any one of the preceding embodiments, further comprising: identifying reference metadata from the browser extension associated with the beacon, wherein the reference metadata comprises characteristics and attributes of the browser extension; identifying second metadata from the new browser extension, wherein the second metadata comprises characteristics and attributes of the new browser extension; and determining whether the new browser extension is the spoofed version of the browser extension based on comparing the reference metadata and the second metadata.
12. The method of any one of the preceding embodiments, wherein the first unique identifier of the browser extension is broken apart into a number of portions and distributed in the new browser extension, and wherein each of the number of portions is encoded.
13. The method of any one of the preceding embodiments, wherein encoding the first unique identifier of the browser extension further comprises transforming the first unique identifier into a human-unreadable format.
14. The method of any one of the preceding embodiments, wherein requesting the browser extension further comprises: transmitting requests to a server, wherein the server maintains a plurality of unique identifiers; and receiving, from the server, one or more of the plurality of unique identifiers.
15. The method of any one of the preceding embodiments, wherein the new browser extension is not verified by a trusted third-party authority, and wherein the new browser extension does not have a valid certificate.
16. One or more non-transitory, computer-readable media having instructions recorded thereon that, when executed by a data processing apparatus, cause the data processing apparatus to perform operations comprising those of any of embodiments 1-15.
17. A system comprising one or more processors; and one or more non-transitory, computer-readable media having instructions recorded thereon that, when executed by the one or more processors, cause operations comprising those of any of embodiments 1-15.
18. A system comprising means for performing any of embodiments 1-15.

What is claimed is:

1. A system for identifying fraudulent browser extensions, the system comprising:
one or more processors; and
one or more non-transitory, computer-readable media having instructions recorded thereon that, when executed by the one or more processors, cause operations comprising:
in response to installation of a new browser extension previously not present on a user device, executing code for a beacon comprising:
retrieving a first unique identifier corresponding to a browser extension associated with the beacon;
retrieving a second unique identifier associated with an embedded frame in the new browser extension;
determining whether the new browser extension is a spoofed version of the browser extension based on whether the first unique identifier of the browser extension matches the second unique identifier of the new browser extension; and
in response to determining that the new browser extension is a spoofed version of the browser extension, executing an application programming interface (API) function to transmit a notification to an external server, the API function configured to generate information to include in the notification regarding the new browser extension.

2. A method for identifying fraudulent browser extensions, the method comprising:
retrieving a first unique identifier corresponding to a browser extension associated with a beacon;
retrieving a second unique identifier associated with an embedded frame in a new browser extension;
determining whether the new browser extension is a spoofed version of the browser extension based on whether the first unique identifier of the browser extension matches the second unique identifier of the new browser extension; and
in response to determining that the new browser extension is a spoofed version of the browser extension, executing an application programming interface (API) function to transmit a notification to an external server, the API function configured to generate information to include in the notification regarding the new browser extension.

3. The method of claim 2, wherein retrieving the first unique identifier corresponding to the browser extension associated with the beacon further comprises:
accessing a local file to retrieve the first unique identifier, wherein the local file comprises the first unique identifier corresponding to the browser extension associated with the beacon, and wherein the local file is stored on a user device that stores the browser extension.

4. The method of claim 3, wherein the local file comprises a first portion of the first unique identifier, and a second local file comprises a second portion of the first unique identifier, and wherein the first unique identifier is a combination of the first portion of the first unique identifier and the second portion of the first unique identifier.

5. The method of claim 2, wherein executing code for the beacon further comprises:
determining whether a first code for the beacon is missing; and
in response to determining that the first code for the beacon is missing, executing a second code for the beacon to determine whether the new browser extension is the spoofed version of the browser extension.

6. The method of claim 2, wherein the browser extension is available from a plurality of sources, wherein each source provides a different unique identifier for the browser extension.

7. The method of claim 6, wherein determining whether the new browser extension is a spoofed version of the browser extension further comprises:
retrieving a third unique identifier corresponding to the browser extension, wherein the third unique identifier corresponds to the browser extension associated with the beacon;
comparing the second unique identifier of the new browser extension with the third unique identifier; and
determining whether the second unique identifier of the new browser extension matches the third unique identifier.

8. The method of claim 2, wherein executing the API function to transmit a notification to an external server comprises a network request and wherein the network request comprises the second unique identifier of the spoofed version of the browser extension.

9. The method of claim 2, further comprising:
identifying reference metadata from the browser extension associated with the beacon, wherein the reference metadata comprises characteristics and attributes of the browser extension;
identifying second metadata from the new browser extension, wherein the second metadata comprises characteristics and attributes of the new browser extension; and
determining whether the new browser extension is the spoofed version of the browser extension based on comparing the reference metadata and the second metadata.

10. The method of claim 2, wherein the first unique identifier of the browser extension is broken apart into a number of portions and distributed in the new browser extension, and wherein each of the number of portions is encoded.

11. The method of claim 10, wherein encoding the first unique identifier of the browser extension further comprises transforming the first unique identifier into a human-unreadable format.

12. The method of claim 2, wherein requesting the browser extension further comprises:
transmitting requests to a server, wherein the server maintains a plurality of unique identifiers; and
receiving, from the server, one or more of the plurality of unique identifiers.

13. The method of claim 2, wherein the new browser extension is not verified by a trusted third-party authority, and wherein the new browser extension does not have a valid certificate.

14. One or more non-transitory, computer-readable media comprising instructions recorded thereon that, when executed by one or more processors, causes operations for identifying fraudulent browser extensions comprising:
identifying a browser extension, wherein the browser extension comprises a first unique identifier corresponding to the browser extension;
identifying a new browser extension, wherein the new browser extension comprises a second unique identifier associated with an embedded frame in the new browser extension;
performing a check of the new browser extension by:
comparing the second unique identifier of the new browser extension with the first unique identifier; and
determining whether the second unique identifier of the new browser extension matches the first unique identifier; and
executing an application programming interface (API) function to transmit a notification to an external server, the API function configured to generate information to include in the notification regarding the new browser extension.

15. The one or more non-transitory, computer-readable media of claim 14, wherein retrieving the first unique identifier corresponding to the browser extension further comprises:
accessing a local file to retrieve the first unique identifier, wherein the local file comprises the first unique identifier corresponding to the browser extension, and wherein the local file is stored on a user device that stores the browser extension.

16. The one or more non-transitory, computer-readable media of claim 15, wherein the local file comprises a first portion of the first unique identifier, and a second local file comprises a second portion of the first unique identifier, and wherein the first unique identifier is a combination of the first portion of the first unique identifier and the second portion of the first unique identifier.

17. The one or more non-transitory, computer-readable media of claim 14, wherein the first unique identifier of the browser extension is broken apart into a number of portions and distributed in the new browser extension, and wherein each of the number of portions is encoded.

18. The one or more non-transitory, computer-readable media of claim 14, wherein the browser extension is available from a plurality of sources, wherein each source provides a different unique identifier for the browser extension.

19. The one or more non-transitory, computer-readable media of claim 18, wherein determining whether the new browser extension is a spoofed version of the browser extension further comprises:
retrieving a third unique identifier corresponding to the browser extension, wherein the third unique identifier corresponds to the browser extension;
comparing the second unique identifier of the new browser extension with the third unique identifier; and
determining whether the second unique identifier of the new browser extension matches the third unique identifier.

20. The one or more non-transitory, computer-readable media of claim 15, wherein executing the API function to transmit a notification to an external server comprises a network request and wherein the network request comprises the second unique identifier of a spoofed version of the browser extension.
